(19) United States
(12) Patent Application Publication
(10) Pub. No.: US 2026/0264803 A1
(43) Pub. Date: Sep. 10, 2026

(54) BICYCLE AND MOTOR CONTROL APPARATUS

(71) Applicant: YAMAHA HATSUDOKI KABUSHIKI KAISHA, Iwata-shi (JP)

(72) Inventor: Toshihiko HIGASHI, Shizuoka (JP)

(21) Appl. No.: 19/554,887

(22) Filed: Mar. 3, 2026

(30) Foreign Application Priority Data
Mar. 5, 2025 (JP) 2025-034734

(51) Int. Cl. B62M 6/45; B62M 6/55; B62M 11/06; B62M 25/08

(52) U.S. Cl. CPC B62M 6/45; B62M 6/55; B62M 11/06; B62M 25/08

(57) ABSTRACT

A bicycle includes a crankshaft, a vehicle wheel, and a transmission that includes a first rotating body, a second rotating body, and a transmission link to transmit a driving force from the first rotating body to the second rotating body. At least one of the first or second rotating body includes a plurality of sprockets. The bicycle includes a speed changer to change a speed change ratio by changing a combination of a sprocket of the first rotating body on which the transmission link is positioned and a sprocket of the second rotating body, and a motor to supply the transmission link with a driving force. A motor controller is configured or programmed to, upon receiving a speed change signal indicative of a speed change operation performed by the speed changer, perform a speed change response control to control the motor such that electric power in the motor remains constant.

### CROSS-REFERENCE TO RELATED APPLICATION

This application is based upon and claims the benefit of priority to Japanese Patent Application No. 2025-34734, filed on Mar. 5, 2025, the entire contents of which are hereby incorporated herein by reference.

### BACKGROUND OF THE INVENTION

### 1. Field of the Invention

The present invention relates to bicycles including speed changers and motors, and apparatuses for controlling motors of bicycles.

### 2. Description of the Related Art

When a user of a bicycle including a speed changer performs a speed change operation, the speed changer displaces the chain, and as the user pedals to rotate the sprockets, the chain moves into engagement with sprockets that are associated with the target speed change level. Bicycles have been developed in which a motor provides a driving force that rotates the sprockets for the speed change to enable switching among speed change levels without the user having to pedal.

For example, JP 2022-104500 A discloses a control apparatus for a human-powered vehicle. When the crankshaft is stationary, the controller of the control apparatus performs a speed change operation to drive the chain by means of a motor and displace the chain by means of a derailleur to change the speed change ratio. The controller provides a first control state in which a speed change operation is performed and a second control state in which the driving force from the motor during the speed change operation is reduced compared with the first control state. If a parameter relating to human-powered driving force is not lower than a first value, the controller transitions to the first control state, and if the parameter relating to human-powered driving force is not higher than a second value, the controller transitions to the second control state. The first value is larger than the second value. Thus, when the rider stops the human-powered vehicle while waiting for a green traffic signal, for example, the driving of the chain by the motor is reduced such that the rider is less likely to have an odd feeling caused by generation of a driving force by the human-powered vehicle.

### SUMMARY OF THE INVENTION

When the chain is being driven by the motor during the speed change, at the time of switching between speed change levels, the rotational speed of the vehicle wheel may temporarily change due to the driving force from the motor. In such a case, the user perceives a change in vehicle speed. This may be prevented by adjusting the driving force from the motor at the time of switching between speed change levels. However, adding an arrangement to detect switching between speed change levels would result in a complicated bicycle, which means increased costs.

Example embodiments of the present invention provide bicycles and control apparatuses that each use a simple arrangement to reduce changes in vehicle speed due to a driving force from a motor at a time of switching between speed change levels.

In a motor control apparatus for a bicycle according to an example embodiment of the present invention, the bicycle includes a crankshaft to receive a pedaling force; a vehicle wheel; a transmission including a first rotating body including at least one sprocket coupled to the crankshaft, a second rotating body including at least one sprocket coupled to the vehicle wheel, and a transmission link to transmit a driving force from the first rotating body to the second rotating body, at least one of the first rotating body or the second rotating body including a plurality of sprockets; a speed changer to change a speed change ratio by changing a combination of a sprocket of the first rotating body from which the transmission link transmits a driving force and a sprocket of the second rotating body to which the transmission link transmits a driving force; and a motor to supply the transmission link with a driving force.

The motor control apparatus includes a motor controller configured or programmed to control the motor.

Upon receiving a speed change signal indicative of a speed change operation by the speed changer, the motor controller is configured or programmed to perform a speed change response control to control the motor such that electric power in the motor remains constant.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view of an exemplary construction of a bicycle.

FIG. 2 shows an exemplary configuration of a transmission system to provide a driving force for the bicycle shown in FIG. 1.

FIG. 3 shows examples of changes over time in the torque of a motor, a rotational speed and rotational angle of a first rotating body, and a vehicle speed during a period of time that includes a speed change response control.

FIGS. 4A to 4D show graphs illustrating examples of operations of the motor and the bicycle when the speed change response control and a control for constant torque are performed.

FIG. 5 is a flow chart showing an example of the operation of the motor controller 5.

FIG. 6 is a flow chart showing another example of the operation of the motor controller 5.

### DETAILED DESCRIPTION OF EXAMPLE EMBODIMENTS

In a motor control apparatus for a bicycle according to an example embodiment of the present invention, the bicycle includes a crankshaft to receive a pedaling force; a vehicle wheel; a transmission including a first rotating body including at least one sprocket coupled to the crankshaft, a second rotating body including at least one sprocket coupled to the vehicle wheel, and a transmission link to transmit a driving force from the first rotating body to the second rotating body, at least one of the first rotating body or the second rotating body including a plurality of sprockets; a speed changer to change a speed change ratio by changing a combination of a sprocket of the first rotating body from which the transmission link transmits a driving force and a sprocket of the second rotating body to which the transmission link transmits a driving force; and a motor to supply the transmission link with a driving force.

The motor control apparatus includes a motor controller configured or programmed to control the motor.

Upon receiving a speed change signal indicative of a speed change operation by the speed changer, the motor controller is configured or programmed to perform a speed change response control to control the motor such that electric power in the motor remains constant.

In the configuration above, when the speed changer performs a speed change operation to change the combination of sprockets on which the transmission link is positioned, the motor controller receives a speed change signal. Upon receiving the speed change signal, the motor controller is configured or programmed to perform a speed change response control to control the motor such that the electric power in the motor remains constant. During the speed change response control, the motor is controlled such that the energy (in watts) of the motor remains constant. The driving force supplied from the motor to the transmission link during the speed change response control supports the speed change operation. Here, the control is not to keep the output torque of the motor constant, but to control the motor such that the electric power therein remains constant. Accordingly, the energy of the driving force supplied from the motor to the transmission link, as measured before and after switching between speed change levels by the speed change operation of the speed changer, remains constant. Thus, for example, the driving force supplied from the motor to the transmission link is adjusted such that, even if speed change ratios before and after switching between speed change levels are different, there is no or little change in the number of rotations of the vehicle wheel. As a result, a simple arrangement enables reduction of changes in vehicle speed caused by the driving force from the motor at the time of switching between speed change levels. The process for controlling the motor such that the electric power in the motor is constant may be, for example, a process for controlling the motor such that the electric power in the motor reaches a target value. In such implementations, the target value is a value that does not change over time.

The bicycle may include a speed change operation detector to detect a speed change operation of the speed changer and output a speed change signal indicative of a speed change operation.

The speed changer may be configured to perform a speed change operation in response to a user operation. In such implementations, the bicycle includes a speed change operator to receive a user speed change operation. In such implementations, the speed change operation detector may be configured to detect a user speed change operation that has been input through the speed change operator, and supply the motor controller with a speed change signal indicative of the user speed change operation. Alternatively, the speed change operation detector may be configured to detect an operation of the speed changer and supply the motor controller with a speed change signal indicative of a user speed change operation.

The speed changer may be configured to automatically perform a speed change operation depending on the vehicle state. In such implementations, the bicycle may include a speed change controller configured or programmed to control the speed changer depending on the vehicle state. The speed change controller is configured or programmed to supply a speed change signal to the motor controller when the speed changer performs a speed change operation depending on the vehicle state.

The speed changer may be configured, for example, to change the sprockets with which the transmission link engages, where the relevant sprockets include at least one of a sprocket of the first rotating body or a sprocket of the second rotating body.

The speed changer may, for example, include a guide that restricts the position of the transmission link and be configured to move the guide in response to a movement of the speed change operator. By way of example, the speed changer may include a base fixed to the frame of the bicycle, a guide movably mounted on the base to guide the transmission link, and a moving mechanism that moves the position of the guide relative to the base and uses the guide to change the position of the transmission link. The moving mechanism may be, for example, configured to move the guide in an interlocked manner with a user operation on the speed change operator. In such implementations, for example, the speed change operator and speed changer may be coupled by a wire that transmits an operating force. Alternatively, an actuator may be included that moves the guide in response to a user operation on the speed change operator, or automatically depending on the vehicle state.

During the speed change response control, the motor controller may be configured or programmed to control the motor such that the electric power therein remains constant within the range of about 2 W to about 20 W, for example. This will efficiently reduce changes in the number of rotations of the vehicle wheel caused by the driving force from the motor, as measured before and after switching between speed change levels. As the electric power in the motor is not more than about 20 W, the user is less likely to feel the driving force from the motor during the speed change operation. To achieve this, the electric power in the motor during the speed change response control is more preferably not more than about 15 W, and yet more preferably not more than about 10 W, for example. Further, so that the motor supplies a sufficient driving force for supporting a speed change operation, the electric power in the motor during the speed change response control is preferably not less than about 2 W, more preferably not less than about 3 W, and yet more preferably not less than about 4 W, for example.

During the speed change response control, the motor controller may be configured or programmed to control the motor such that the electric power remains constant by controlling a torque of the motor depending on a rotational speed of the motor. This will enable efficiently performing the speed change response control. The rotational speed of the motor that is used by the motor controller may be the detected rotational speed of the motor, or may be a rotational speed determined based on the rotational speed of the crankshaft, a sprocket, or any other rotating body that rotates together with the rotation of the motor. The detected rotational speed of the motor may be, for example, the number of rotations per unit time of the motor.

The motor control apparatus or the bicycle may include a motor sensor to detect a voltage across or a rotational speed of the motor. The motor sensor may include a motor voltage detector or a motor rotational speed detector. During the speed change response control, the motor controller may be configured or programmed to control the torque of the motor depending on the rotational speed of the motor detected by the motor sensor or the rotational speed of the motor calculated based on the voltage across the motor detected by the motor sensor. For example, during the speed change response control, the motor controller may be configured or programmed to control the torque of the motor by controlling at least one of the electric current of or the voltage across the motor. For example, the motor controller may be configured or programmed to control the torque of the motor by controlling the voltage across the motor. In controlling the voltage across the motor during the speed change response control, for example, the voltage across the motor detected by the motor sensor may be used.

The motor sensor may detect the electric current of the motor. In other words, the motor sensor may include a current detector for the motor. For example, in controlling the electric current of the motor during the speed change response control, the electric current of the motor detected by the motor sensor may be used.

By way of example, the motor controller may be configured or programmed to control the motor such that the electric power therein remains constant by increasing the electric current of the motor to increase the torque if the rotational speed of the motor has decreased and reducing the electric current of the motor to reduce the torque if the rotational speed of the motor has increased.

The process performed by the motor controller configured or programmed to control the motor such that the electric power in the motor remains constant may be, for example, a process to control the motor such that the electric power in the motor comes closer to a target value. As an example of such a process, the motor controller may be configured or programmed to control the current of and/or the voltage across the motor based on the amount of difference between the electric power calculated from the rotational speed and the electric current of the motor that have been detected, on the one hand, and the target value, on the other. Alternatively, the motor controller may be configured or programmed to control the current of and/or the voltage across the motor based on the amount of difference between the electric power calculated from the voltage across and the current of the motor that have been detected, on the one hand, and the target value, on the other.

The motor controller may be configured or programmed to perform the speed change response control when a vehicle speed of the bicycle at a time of receiving the speed change signal satisfies a predetermined vehicle speed condition, and not to perform the speed change response control when the vehicle speed of the bicycle at the time of receiving the speed change signal does not satisfy the vehicle speed condition. In other words, the motor controller determines whether to perform the speed change response control based on the vehicle speed at the time of a speed change operation. This allows controlling the motor to support or not support a speed change operation with its driving force depending on the vehicle speed. This enables appropriate support of a speed change operation by the motor. It is to be understood that the vehicle speed of the bicycle at the time of receiving a speed change signal does not necessarily need to be the vehicle speed at the point in time that exactly matches the time of receiving the speed change signal. It is sufficient if the vehicle speed that provides the basis for determining whether to perform the speed change response control is the vehicle speed at a point in time that can be considered to be the time of the speed change operation.

For example, the motor controller may be configured or programmed not to perform the speed change response control when the vehicle speed at the time of receiving a speed change signal is not less than a threshold value. Alternatively or additionally, the motor controller may be configured or programmed not to perform the speed change response control when the vehicle speed at the time of receiving the speed change signal is not more than a threshold value. In other words, the motor controller may be configured or programmed, upon receiving a speed change signal, to perform the speed change response control when the vehicle speed at that time is within a predetermined range, and not to perform the speed change response control when the vehicle speed is outside the predetermined range.

The motor controller may terminate the speed change response control when a speed change response control termination condition is satisfied. This enables terminating the speed change response control at an appropriate point in time. The motor controller 5 terminates the speed change response control by, for example, stopping the driving by the motor or switching to another type of control (e.g., assist control).

The speed change response control termination condition may include an amount of rotation of the first rotating body reaching a first threshold value or an amount of rotation of the second rotating body reaching the first threshold value. This will enable terminating the speed change response control in a manner that matches the point in time of switching between speed change levels. In such implementations, the first threshold value may be in a range of 90° to 360°, for example. Further, for example, the first threshold value may be a value depending on the speed change ratio resulting from the speed change operation. The period of time required for switching between speed change levels for the speed change operation varies depending on the difference between the number of teeth of the gear on that speed change level sprocket of the first rotating body with which the transmission link engages after switching, on the one hand, and the number of teeth of the gear on that sprocket of the second rotating body with which the transmission link engages after switching. Thus, deciding on a first threshold value depending on the speed change ratio will enable matching the termination of the speed change response control with the point in time of switching between speed change levels.

The speed change response control termination condition may include a change in a number of motor rotations satisfying a predetermined condition. This will enable terminating the speed change response control in a manner that matches the point in time of switching between speed change levels. For example, the motor controller may be configured or programmed to determine that the number of motor rotations satisfies the predetermined condition if an increase in the number of motor rotations equal to or greater than a threshold range and a decrease equal to or greater than the threshold range are contained in a predetermined period of time.

The motor controller may be configured or programmed to perform an assist control to cause the motor to output a driving force depending on a pedaling force by a user at a higher priority than the speed change response control. This will enable providing both the assist control and the speed change response control.

During the assist control, the motor controller may be configured or programmed to control the motor such that the output torque of the motor reaches a target torque that depends on the pedaling force by the user.

As one example, during the speed change response control, the motor controller may be configured or programmed to stop the speed change response control and perform the assist control when a pedaling force by the user has been detected. Additionally or alternatively, the motor controller may be configured or programmed not to perform the speed change response control when it has received the speed change signal during the assist control.

The motor controller may be configured or programmed to terminate the speed change response control when a speed change response control termination condition is satisfied. In such implementations, during the speed change response control, the motor controller may be configured or programmed to stop the speed change response control and perform the assist control when a pedaling force by the user is detected, and not to resume the stopped speed change response control when the assist control has been terminated before the speed change response control termination condition is satisfied.

The motor controller may be configured or programmed to terminate the speed change response control when the speed change response control termination condition is satisfied. In such implementations, during the speed change response control, the motor controller may be configured or programmed to stop the speed change response control and perform the assist control when a pedaling force by the user is detected, and resume the stopped speed change response control when the assist control is terminated before the speed change response control termination condition is satisfied.

A limit of a rate of increase in a torque of the motor per unit time during the speed change response control may be provided. Within the speed change response control, if the motor is controlled such that the electric power in the motor remains constant, the torque is large in regions where the rotational speed of the motor is low, such as when the bicycle is starting to travel. Thus, providing a limit to the rate of increase in torque will prevent a rapid rise in torque in regions with small numbers of rotations.

For example, when the motor controller, within the speed change response control, determines a motor current value to keep the electric power constant depending on the rotational speed of the motor or the voltage across the motor, the unit may determine such a current value that the rate of increase in the motor current value remains within a predetermined range. This will limit the rate of increase in motor torque per unit time.

In the motor controller, the speed change response control may also include a process to increase the torque of the motor until the electric power in the motor reaches a target value, and a process to adjust the torque depending on the number of motor rotations to maintain the electric power in the motor at the target value. In such implementations, providing a limit of the rate of increase in torque per unit time will enable preventing a rapid increase in torque and a rapid change in vehicle speed during the period of time from the initiation of the speed change response control until the electric power in the motor reaches the target value.

A bicycle according to an example embodiment of the present invention may include the motor controller according to any one of the example embodiments described above. A bicycle according to an example embodiment of the present invention includes a crankshaft to receive a pedaling force; a vehicle wheel; a transmission including a first rotating body including at least one sprocket coupled to the crankshaft, a second rotating body including at least one sprocket coupled to the vehicle wheel, and a transmission link to transmit a driving force from the first rotating body to the second rotating body, at least one of the first rotating body or the second rotating body including a plurality of sprockets; a speed changer to change a speed change ratio by changing a combination of a sprocket of the first rotating body from which the transmission link transmits a driving force and a sprocket of the second rotating body to which the transmission link transmits a driving force; a motor to supply the transmission link with a driving force; and a motor controller configured or programmed to control the motor.

Upon receiving a speed change signal indicative of a speed change operation by the speed changer, the motor controller is configured or programmed to perform a speed change response control to control the motor such that electric power in the motor remains constant.

The motor control apparatus according to any one of example embodiments described above may include the motor, for example. Further, the motor control apparatus may include the motor and a housing to house the motor. In such implementations, the motor control apparatus defines the drive unit. Furthermore, the motor control apparatus may include a motor sensor to detect, in addition to the voltage across or the rotational speed of the motor, the electric current of the motor. In such implementations, the motor controller may be configured or programmed to control the motor such that the electric power remains constant by controlling the torque of the motor depending on the rotational speed of the motor detected by the motor sensor, for example.

Now, systems according to example embodiments of the present invention will be described with reference to the drawings. In the drawings, the same or corresponding elements are labeled with the same reference numerals, and their description will not be repeated. In the description provided below, “front/forward” and “rear (ward)”, “left” and “right”, and “top/up (ward)” and “bottom/down (ward)” of a bicycle refer to such directions as perceived by a user sitting on the saddle (i.e., seat 24) and grasping the handlebars 23. The directions “front/forward” and “rear (ward)”, “left” and “right”, and “top/up (ward)” and “bottom/down (ward)” of the human-powered vehicle are the same as the respective directions of the vehicle body, i.e., vehicle body frame, of the bicycle. Furthermore, the forward direction of the bicycle is aligned with the front-rear direction of the bicycle. In one example embodiment, the term “speed change” may also be referred to as “gear change”, “shift change”, or “transmission change”. The example embodiments described below are merely illustrative, and the present invention is not limited to the example embodiments described below.

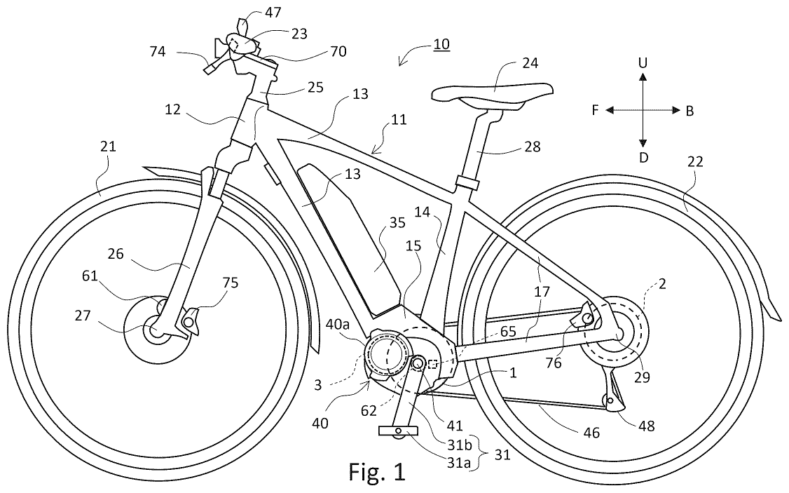

FIG. 1 is a left side view of an exemplary construction of a bicycle 10. The signs “F”, “B”, “U”, and “D” in FIG. 1 refer to “forward”, “rearward”, “upward” and “downward”, respectively. By way of example, the bicycle 10 is an electric motor-assisted bicycle. The bicycle 10 includes a plurality of vehicle wheels 21 and 22, a vehicle body frame 11, a motor 3, a crankshaft 41, and a transmission to transmit a driving force from the crankshaft 41 to at least one of the vehicle wheels 21 and 22 (by way of example, vehicle wheel 22 in FIG. 1). The transmission includes a first rotating body 1, a second rotating body 2 and a transmission link 46. The first rotating body 1 includes at least one sprocket coupled to the crankshaft 41. The second rotating body 2 includes at least one sprocket coupled to the vehicle wheel 22. At least one of the first and second rotating bodies 1 and 2 includes a plurality of sprockets. The transmission link 46 transmits a driving force from the first rotating body to the second rotating body.

Pedals 31 are mounted on both ends of the crankshaft 41, to the left and right. Each pedal 31 includes a crank arm 31b and a step 31a. The crankshaft 41 receives a pedaling force via the pedals 31. Specifically, crank arms 31b are mounted on both ends of the crankshaft 41. For each crank arm 31b, a pedal step 31a is mounted on its distal end. As the user presses the pedals 31, the crankshaft 41 rotates.

The driving force from the pedaling force is transmitted from the crankshaft 41 to the first rotating body 1, the transmission link 46, and the second rotating body before reaching the vehicle wheel 22. On the transmission path of the driving force from the crankshaft 41 to the vehicle wheel 22 are disposed the first rotating body 1, the transmission link 46, and the second rotating body 2 in this order. The sprocket(s) of the first rotating body 1 is/are coupled to the crankshaft 41 with a one-way clutch provided in between, for example. The sprocket(s) of the first rotating body 1 may be coaxial with the crankshaft 41, or may not be coaxial. The sprocket(s) of the second rotating body 2 is/are coupled to the vehicle wheel 22 with a one-way clutch provided in between, for example. The sprocket(s) of the second rotating body 2 may be coaxial with the vehicle wheel 22, or may not be coaxial. Each one-way clutch is configured to transmit rotation in a direction that causes the bicycle 10 to travel forward, i.e., rotation in the forward direction (i.e., forward rotation), but not to transmit rotation in a rearward direction, i.e., rearward rotation. Each one-way clutch may include at least one of a roller clutch, a sprag clutch or a claw clutch, for example.

The transmission link 46 engages with one sprocket of the first rotating body and one sprocket of the second rotating body 2. In other words, the transmission link 46 is positioned on a pair of sprockets, i.e., one sprocket of the first rotating body and one sprocket of the second rotating body 2. At least one of the first or second rotating body 1 or 2 includes a plurality of sprockets. The transmission link 46 is selectively positioned, i.e., positioned on one of the relevant sprockets. The transmission link 46 may be, for example, a chain wound around one sprocket of the first rotating body 1 and one sprocket of the second rotating body 2. Alternatively, the transmission link 46 may be a shaft including two gears, located on the respective ends of the shaft, where one gear engages with one sprocket of the first rotating body and the other gear engages with one sprocket of the second rotating body.

The bicycle 10 further includes a speed changer 48. The speed changer 48 changes the speed change ratio by changing the set of sprockets on which the transmission link is positioned. The speed change ratio represents the ratio of the rotational speed of the vehicle wheel to the rotational speed of the crankshaft. For example, the speed change ratio may be expressed based on the ratio between the number of teeth of a sprocket of the first rotating body 1 and the number of teeth of a sprocket of the second rotating body 2. Alternatively, changes in the speed change ratio may be represented by changes in the speed change level. The speed changer 48 changes the combination of a sprocket of the first rotating body 1 to which a driving force is transmitted and a sprocket of the second rotating body 2 by changing (e.g., shifting) the position of the transmission link 46. The speed changer 48 may be, for example, an external speed changer. The speed changer 48 may be configured to perform speed change operations in an interlocked manner with a user input. Alternatively, the speed changer 48 may include an actuator, and may be configured to perform speed change operations by using a driving force from the actuator. In implementations where the speed changer 48 includes an actuator, the actuator may be driven in response to a user operation, or may be automatically driven depending on the state of the vehicle.

The speed changer includes, for example, a derailleur. The derailleur changes the speed change ratio by moving the transmission link, i.e., chain, in position, thus changing the pair of sprockets, i.e., one sprocket of the first rotating body and one sprocket of the second rotating body, around which the chain is wound. The derailleur may include, for example, a base fixed to the vehicle body frame 11, a guide movably mounted on the base, and a moving mechanism that moves the guide. A movement of the guide changes the position of the transmission link. The guide may include, for example, a guide plate and a pulley, or may include a guide plate only. The moving mechanism may include, for example, a wire that interlocks the movement of a speed change operator 47 of the bicycle 10 with the guide. Alternatively, the moving mechanism may include an actuator that moves the guide.

The speed changer includes, for example, at least one of a front derailleur or a rear derailleur. The front derailleur positions the transmission link (e.g., chain) on one of the plurality of sprockets included in the first rotating body. In implementations where the speed changer includes a front derailleur, the first rotating body includes a plurality of sprockets, and the second rotating body includes at least one sprocket. The rear derailleur positions the transmission link on one of the plurality of sprockets included in the second rotating body. In implementations where the speed changer includes a rear derailleur, the first rotating body includes at least one sprocket, and the second rotating body includes a plurality of sprockets.

The bicycle 10 includes a motor 3. The motor 3 supplies the transmission link 46 with a driving force. In other words, the motor 3 serves as a power source of the driving force. The driving force from the motor 3 is transmitted to the transmission link 46 and then the second rotating body 2 before reaching the vehicle wheel 22. The driving force from the motor 3 may be transmitted to the transmission link 46 via the first rotating body 1, or may be transmitted to the transmission link 46 without passing through the first rotating body 1. A decelerator (i.e., gear) may be provided on the transmission path of the driving force from the motor 3 to the transmission link 46. A one-way clutch may also be provided on the transmission path of the driving force from the motor 3 to the transmission link 46.

In the implementation of FIG. 1, the motor 3 is included in a drive unit 40. The drive unit 40 is mounted on the vehicle body frame 11. By way of example, the drive unit 40 is attached to a lower portion of a bracket 15, which is connected to the vehicle body frame 11 by fasteners (not shown). The drive unit 40 includes a housing 40a that defines the outer shape of the drive unit 40. The motor 3 is accommodated inside the housing 40a. A crankshaft 41 extends through the housing 40a in the left-right direction. The crankshaft 41 is rotatably supported on the housing 40a by a plurality of bearings. The drive unit 40 may further include a decelerator (i.e., gear) that transmits the rotation of the motor 3 while reducing its speed.

The drive unit 40 may further include a synthesizing mechanism that synthesizes the rotation of the motor 3 and the rotation of the crankshaft 41 and transmits the resulting rotation to the first rotating body 1. In such implementations, the driving force from the motor 3 is transmitted to the transmission link 46 via the first rotating body 1. The synthesizing mechanism includes, for example, a cylindrical member coaxial with the crankshaft. The crankshaft 41 is positioned inside the cylindrical member. The sprocket(s) of the first rotating body 1 is/are mounted on the cylindrical member. The rotation of the motor 3 is transmitted to the cylindrical member via a gear, for example. The cylindrical member rotates about the same rotational axis as the crankshaft 41 and the sprocket(s) of the first rotating body 1. A one-way clutch may be provided on the transmission path of the driving force from the crankshaft 41 to the synthesizing mechanism, and a one-way clutch may be provided on the transmission path of the driving force from the motor 3 to the synthesizing mechanism. In a variation, the rotation of the motor 3 may be transmitted to a sprocket that is separate from the first rotating body 1 and engages with the transmission link 46. In such implementations, the driving force from the motor 3 is transmitted to the transmission link 46 without passing through the first rotating body 1.

In the implementation shown in FIG. 1, the vehicle body frame 11 includes a head pipe 12, a front frame portion 13, a seat frame portion 14, and rear stays 17. The front frame portion 13 is located between the head pipe 12 and seat frame portion 14. The seat frame portion 14 is located between the front and rear frame portions 13 and 17 to support a seat 24. The rear frame portions 17 extend rearward from the seat frame portion 14 to support the axle of the vehicle wheel 22. In the implementation of FIG. 1, the front frame portion 13 includes a down tube and an upper tube; alternatively, the front frame portion may include a single tube. In the implementation of FIG. 1, each rear frame portion 17 includes a seat stay and a chain stay; alternatively, one of them may be omitted. Thus, the vehicle body frame 11 rotatably supports a handle stem 25 at the front and rotatably supports the rear wheel 22 at the rear. Further, the seat 24 and the drive unit 40 are mounted on the vehicle body frame 11. The drive unit 40 is mounted on the bracket 15 of the vehicle body frame 11. The bracket 15 is coupled to at least one of the front frame portion 13, the seat frame portion 14 or a rear frame portion 17. In the implementation of FIG. 1, the bracket 15 is coupled to the seat frame portion 14 and front frame portion 13. Alternatively, the drive unit may be mounted on the vehicle body frame without using a bracket.

A handle stem (i.e., steering column) 25 is inserted into the head pipe 12 so as to be rotatable. The handlebars 23 are fixed to the upper end of the handle stem 25. A front fork 26 is fixed to the lower end of the handle stem 25. The front wheel 21 is rotatably supported on the lower end of the front fork 26 by an axle 27.

A grip is attached to each of the left and right ends of the handlebars 23. A left brake lever 74 is attached to a location on the handlebars 23 toward the left, whereas a right brake lever 74 is attached to a location on the handlebars 23 toward the right. The left brake lever 74 enables operating a brake 76 for the rear wheel 22. The right brake lever 74 enables operating a brake 75 for the front wheel 21.

In the implementation of FIG. 1, a speed change operator 47 is provided on the handlebars 23. The speed change operator 47 receives a user speed change operation. The speed change operator 47 may be a shifter, for example. The speed change operator 47 is coupled to the speed changer 48 by a wire, or electrically connected thereto.

A pedaling force sensor 62 is provided around the crankshaft 41 to detect a pedaling force applied by the user. The pedaling force sensor 62 detects a torque that rotates the crankshaft 41 about its axis. The pedaling force sensor 62 may be, for example, a non-contact torque sensor such as a magnetostrictive sensor, or a contact torque sensor such as an elastic body variable detection-type sensor. A magnetostrictive torque sensor includes a magnetostrictive member that produces magnetostrictive effects and that receives a rotational force of the crankshaft, and a detection coil that detects a change in magnetic permeability caused by a force from the magnetostrictive member.

The bicycle 10 includes a crank rotation sensor 65. The crank rotation sensor 65 detects rotation of the crankshaft 41. The crank rotation sensor 65 may include, for example, a detected element that rotates together with the crankshaft 41, and a detecting element fixed to the vehicle body frame 11 to detect rotation of the detected element. The detecting element is able to detect the detected element in a mechanical, optical, or magnetic manner. The crank rotation sensor 65 may be provided on the drive unit, for example.

The bicycle 10 includes a vehicle speed sensor (or speed sensor). The vehicle speed sensor detects at least the speed of the bicycle 10 in a forward direction. The vehicle speed sensor may be, for example, a sensor that detects rotation of the vehicle body. In the implementation of FIG. 1, the vehicle speed sensor 61 is provided on the front fork 26 to detect rotation of the front wheel 21. The vehicle speed sensor 61 includes, for example, a detected element that rotates together with the front wheel 21 (i.e., vehicle wheel), and a detecting element fixed to the vehicle body frame 11 to detect rotation of the detected element. The detecting element detects the detected element in a mechanical, magnetic, or optical manner. In other implementations, the vehicle speed sensor 61 may detect rotation of the rear wheel 22. In yet other implementations, the vehicle speed sensor 61 may detect rotation of a rotating body other than the vehicle wheels that rotates as the bicycle 10 travels forward, such as the motor 3, crankshaft 41, transmission gear, or chain, for example.

A battery unit 35 is positioned on the vehicle body frame 11. The battery unit 35 supplies the motor 3 of the drive unit 40 with electric power. The battery unit 35 includes a battery and a battery controller, not shown. The battery is a chargeable battery that can be charged and discharged. The battery controller is configured or programmed to control the charging and discharging of the battery and, at the same time, monitors output current, remaining capacity, and other information about the battery.

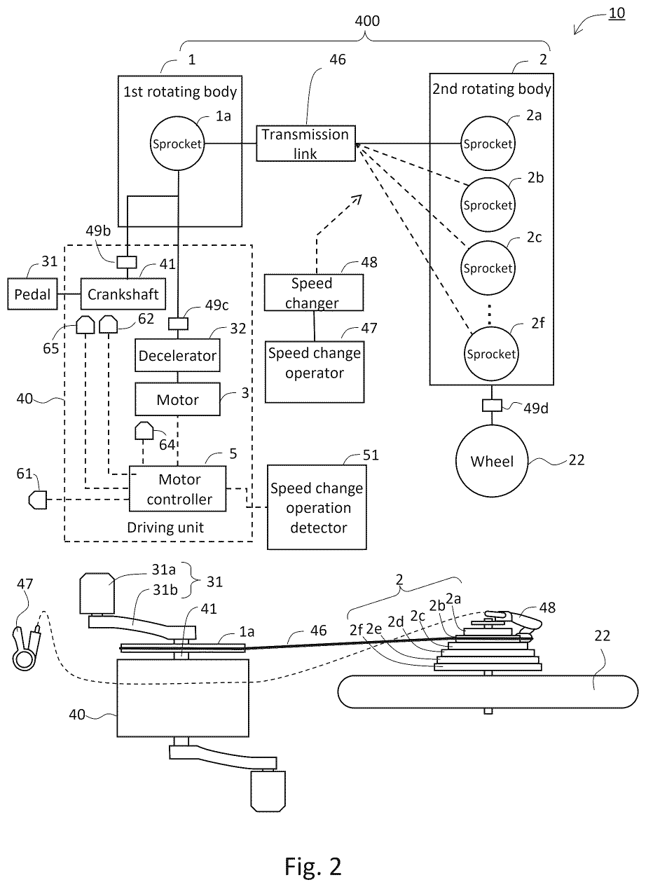

FIG. 2 shows an exemplary configuration of a transmission system of a driving force for the bicycle shown in FIG. 1. In the implementation of FIG. 2, the transmission 400 includes the first rotating body 1, the transmission link 46 and the second rotating body 2. By way of example, the transmission link 46 may be a chain. The chain is wound around a sprocket 1a of the first rotating body 1 and one of sprockets 2a to 2f of the second rotating body 2. The speed changer 48 changes the position of the chain to change the sprockets with which the chain engages. The speed changer 48 operates according to an operation input by the user through the speed change operator 47. The crankshaft 41 is coupled to the first rotating body 1 with the one-way clutch 49b positioned in between. The decelerator 32 and one-way clutch 49c are provided on the transmission path of the driving force between the motor 3 and first rotating body 1. The second rotating body 2 is coupled to the vehicle wheel 22 with the one-way clutch 49d positioned in between.

In the implementation of FIG. 2, the bicycle 10 includes a motor controller 5 and a speed change operation detector 51. The motor controller 5 is configured or programmed to control the motor 3. The speed change operation detector 51 detects a speed change operation of the speed changer 48. The speed change operation detector 51 may detect a speed change operation by detecting a movement of the speed changer 48 or speed change operator 47, for example. When the speed change operation detector 51 detects a speed change operation, it provides a speed change signal indicative of a speed change operation to the motor controller 5. By way of example, the speed change operation detector 51 may be a sensor that converts a speed change operation of the speed changer 48 or speed change operator 57 to a speed change signal indicative of a speed change operation before outputting it.

When the motor controller 5 has received a speed change signal from the speed change operation detector 51, the unit performs the speed change response control. The speed change response control is a control to drive the motor such that the electric power in the motor remains constant. The speed change response control is performed on the condition that a speed change operation has been detected. During the speed change response control, when the speed changer 48 is performing a speed change operation, the motor 3 supplies the transmission link 46 with a driving power. Thus, during the speed change operation, the sprockets on which the transmission link 46 is positioned can be smoothly changed without the user applying a pedaling force to the crankshaft 41. Further, during the speed change response control, the energy of the driving force supplied by the motor to the transmission link, as measured before and after switching between speed change levels, remains constant. Thus, a simple arrangement will enable reducing changes in vehicle speed caused by the driving force from the motor at the time of switching between speed change levels.

The bicycle 10 includes a motor sensor 64. By way of example, the motor sensor 64 detects the voltage across or the rotational speed of the motor, and, in addition, the electric current of the motor. The motor sensor 64 may include a motor voltage detector or a motor rotational speed detector, and, in addition, a motor current detector, for example. The motor controller 5 acquires the motor voltage or motor rotational speed and motor current detected by the motor sensor 64.

The detection of a speed change operation, i.e., reception of a speed change signal, provides a condition for initiating the speed change response control by the motor controller 5. Conditions for initiating the speed change response control may include conditions relating to other states of the bicycle. For example, conditions for initiating the speed change response control may include at least one of a vehicle speed or pedaling force during the speed change operation.

By way of example, when the bicycle can be considered to be stationary (i.e., when the vehicle speed is not higher than a threshold value), the motor controller 5 may be configured or programmed not to perform the speed change response control even if it has received a speed change signal. Additionally or alternatively, the motor controller 5 may be configured or programmed not to perform the speed change response control even if it has received a speed change signal if the vehicle speed is above a predetermined upper limit speed (e.g., assist upper limit speed).

The motor controller 5 may be configured or programmed, when a pedaling force has been detected and the unit is performing an assist control to cause the motor 3 to output a driving force corresponding to the pedaling force, not to perform the speed change response control even if the unit has received a speed change signal. This is an implementation where the motor controller 5 performs the assist control at a higher priority than the speed change response control.

In the motor controller 5, conditions for initiating the speed change response control may not include rotation of the crankshaft. In other words, the motor controller 5, upon receiving a speed change signal, may perform the speed change response control regardless of whether there is rotation of the crankshaft. This will simplify the process for the speed change response control. Alternatively, conditions for initiating the speed change response control may include rotation of the crankshaft.

After initiating the speed change response control, the motor controller 5 may terminate the speed change response control when the state of the bicycle satisfies a predetermined speed change response control termination condition. Speed change response control termination conditions may include, for example, a condition relating to at least one of the amount of rotation of the first or second rotating body 1 or 2, the elapsed time from the initiation of the speed change response control, or a pattern of changes in the number of motor rotations. Thus, even without a device for directly detecting that the speed changer has engaged the transmission link with the target sprocket for the speed change, it is possible to terminate the speed change response control in a way that matches the termination of a speed change operation to some degree. In such implementations, the motor controller 5 may terminate the speed change response control by stopping the driving by the motor, for example.

By way of example, speed change response control termination conditions may include the amount of rotation of the first rotating body 1 after initiation of a speed change response control having reached a first threshold value, or the amount of rotation of the second rotating body 2 after initiation of a speed change response control having reached the first threshold value. For example, after initiation of a speed change response control and when the amount of rotation of the sprocket of the first rotating body 1 has reached the first threshold value (e.g., predetermined rotational angle), the motor controller 5 may stop the driving by the motor to terminate the speed change response control. Although not limiting, the first threshold value may be 120° to 360°, for example, and is preferably 160° to 330°, and more preferably 180° to 300°.

The first threshold value may be determined depending on the speed change ratio after a change by a speed change operation. For example, a speed change signal that may be received by the motor controller 5 may be a signal indicative of a speed change operation and a speed change level after a change by the speed change operation. For example, the speed change operation detector 51 may detect a speed change operation by detecting a speed change level after a change by that speed change operation, i.e., the speed change level representing the change target. The speed change operation detector 51 may supply the motor controller 5 with a speed change signal indicative of a speed change operation and a speed level. The motor controller 5, upon receiving the speed change signal, may initiate the speed change response control and determine the first threshold value based on the speed change level contained in the speed change signal.

Speed change response control termination conditions may include the change in the number of motor rotations satisfying a predetermined condition. The speed change response control termination condition may be, for example, the number of motor rotations indicating a spike change. A spike change in the number of motor rotations may be, for example, changes that include an increase in the number of motor rotations equal to or greater than a threshold range and a decrease equal to or greater than the threshold range within a predetermined period of time. The inventors have discovered that switching between speed change levels during the speed change response control causes a spike change in the number of motor rotations. The motor controller 5 may be configured or programmed to terminate the speed change response control upon detection of a spike change in the number of motor rotations during the speed change response control. This will enable terminating the speed change response control upon switching between speed change levels.

Speed change response control termination conditions may include at least one of a condition relating to the vehicle speed detected during the speed change response control or a condition relating to the pedaling force detected during the speed change response control. In such implementations, the motor controller 5 may terminate the speed change response control by stopping the driving by the motor, for example. For example, in addition to a condition relating to at least one of the amount of rotation of the first or second rotating body 1 or 2, the elapsed time from the initiation of the speed change response control, or the pattern of changes in the number of motor rotations, speed change response control termination conditions may include a condition relating to at least one of vehicle speed or pedaling force.

By way of example, the motor controller 5 may determine that a speed change response control termination condition is satisfied if the vehicle speed detected during the speed change response control is within a range of vehicle speeds that allows determination that the bicycle is stationary (e.g., if the vehicle speed is not higher than a threshold value), and terminate the speed change response control. Additionally or alternatively, the motor controller 5 may determine that a speed change response control termination condition is satisfied if the vehicle speed detected during the speed change response control is above a predetermined upper limit speed (e.g., assist upper limit speed), and terminate the speed change response control.

By way of example, the motor controller 5 may terminate the speed change response control when such a pedaling force as to require assistance during the speed change response control has been detected. In such implementations, the motor controller 5 terminates the speed change response control and initiates the assist control. This is an implementation where the motor controller 5 performs the assist control at a higher priority than the speed change response control.

During the speed change response control, the motor controller 5 performs a control to maintain a constant electric power in the motor. For example, the motor controller 5 may keep the electric power in the motor 3 constant by controlling the torque of the motor 3 depending on the rotational speed of the motor 3 detected by the motor sensor 64.

By way of example, the motor controller 5 acquires a rotational speed wc of the motor from the motor sensor 64. The motor controller 5 calculates a target torque value Tt from the motor rotational speed wc and a target power value Pt. For example, the target torque value Tt may be calculated by Tt=Pt/wc. The motor controller 5 controls the electric current of the motor to bring it closer to an electric current value that corresponds to the target torque value Tt. The control of the electric current of the motor may use feedback control, for example. The feedback control adjusts the electric current of the motor to reduce the deviation of the electric current of the motor detected by the motor sensor 64 from the target current value, for example.

In other implementations, the motor controller 5 acquires a voltage Vc across and an electric current I of the motor from the motor sensor 64. The motor controller 5 calculates the electric power Pc in the motor from the voltage across and the current of the motor. The electric power Pc may be calculated by Pc=Vc×Ic, for example. The motor controller 5 adjusts at least one of the electric current of the motor and the voltage across the motor to reduce the deviation of the electric power Pc from the target current value Pt.

During the speed change response control, the control to keep the electric power in the motor constant is not limited to a control to maintain the electric power in the motor exactly matching the target value. For example, the control to keep the electric power in the motor constant encompasses implementations where the motor is controlled such that the electric power in the motor remains within a predetermined tolerance relative to the target value (e.g., the difference from the target value is within about 10%). Further, the entire period of time where the speed change response control is being performed may include a time section where the electric power in the motor is constant and, in addition, a section where the electric power in the motor is not constant. For example, when the speed change response control is initiated with the electric power in the motor being at zero, the period of time from the point at which the electric power in the motor is zero until it reaches a value near the target value will include some time section where the electric power is not constant. Such an implementation is an example of the speed change response control to control the motor such that the electric power in the motor is constant.

The motor controller 5 may include, for example, one or more computers. The computer may include, for example, a CPU, a micro-processing unit (MPU), a micro-controller unit (MCU), a programmable logic device (PLD), a field-programmable gate array (FPGA), an application-specific integrated circuit (ASIC), or other ICs. The functions of the motor controller 5 may be implemented by the computer(s) executing a pre-recorded program. A program for causing the motor controller 5 to perform motor control processes, as well as a non-transitory storage medium storing such a program, are also encompassed by example embodiments of the present invention.

An exemplary flow of the speed change operation by the speed changer 48 and the speed change response control by the motor controller 5 will now be described. First, when the user performs a user speed change operation on the speed change operator 47, the speed changer 48 initiates its speed change operation and moves the transmission link 46 to the position of a target speed change level. The speed change operation detector 51 detects a movement of the speed change operator 47 or speed changer 48 and supplies a speed change signal to the motor controller 5. The motor controller 5, upon receiving the speed change signal, initiates the speed change response control. The initiation of the speed change response control starts the driving by the motor 3. This moves the transmission link 46 such that the second rotating body 2 starts to rotate. Rotation of the second rotating body 2 causes the transmission link 46 to engage with the sprocket of the target speed change level of the second rotating body 2. Switching between speed change levels thus occurs. Switching between speed change levels changes the speed change ratio. The speed change response control continues to be performed during switching between speed change levels. In other words, the motor is controlled such that the electric power in the motor, as measured before and after switching between speed change levels, is constant. Thus, the change in the speed change ratio prevents the rotational speed of the vehicle wheel 22, which is rotated by the driving force by the motor, from changing. When the speed change response control termination conditions is/are satisfied, the speed change response control is terminated, and the driving by the motor stops. For example, a speed change response control termination condition is the sprocket of the first rotating body 1 (i.e., front sprocket) having rotated a predetermined angle.

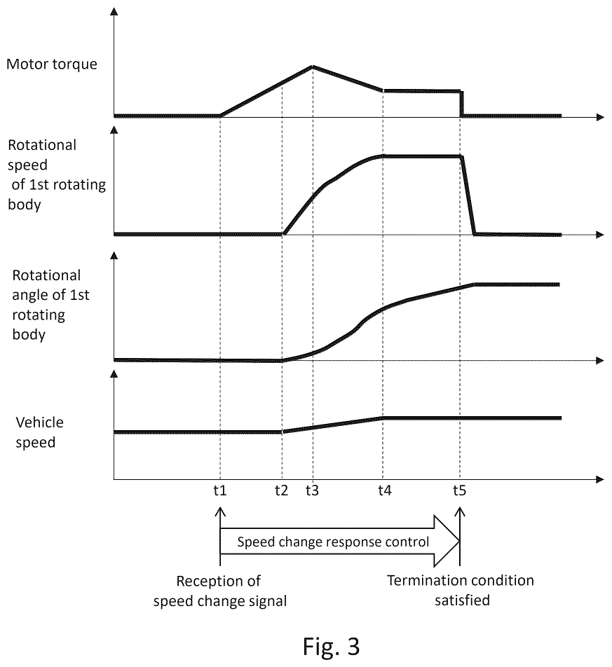

FIG. 3 shows examples of changes over time in the torque of the motor 3, the rotational speed and rotational angle of the first rotating body 1, and the vehicle speed in a period of time that includes the speed change response control. In the implementation of FIG. 3, at time t1, the motor controller 5 receives a speed change signal and initiates the speed change response control. The initiation of the speed change response control starts the driving by the motor. Thus, the speed change response control is initiated together with the initiation of the speed change operation of the speed changer. It is to be understood that the initiation of the operation of the speed changer and the initiation of the speed change response control do not necessarily need to occur exactly at the same time. For example, the speed change response control may be initiated before or after a movement of the speed changer by a small time difference. Since the electric power in the motor is not yet at the target value at the initiation point t1 of the speed change response control, the motor controller 5 increases the electric current of the motor to increase the torque of the motor.

Until time t2, which is directly after the initiation of the speed change response control, the motor does not rotate due to lost torque. From time t2 onward, the torque of the motor 3 increases the rotational speed of the first rotating body 1. At time t3, the electric power in the motor reaches the target value. From time t3 onward, the motor controller 5 adjusts the torque of the motor to maintain the electric power in the motor at the target value. In the implementation of FIG. 3, from time t4 onward, the driving force for the vehicle wheel that receives the torque of the motor to rotate and the load during travel are balanced such that the driving by the motor remains at a constant rotational speed of the motor. At time t5, the speed change response control termination conditions is/are satisfied, and the motor controller 5 terminates the speed change response control to stop the driving by the motor. In the implementation of FIG. 3, during the period of time of the speed change response control, the motor is controlled such that both the torque and rotational speed of the motor increase until the electric power in the motor reaches the target value and, after the electric power in the motor has reached the target value, an increase in the rotational speed of the motor reduces the torque. The motor controller 5 controls the motor such that a decrease in the rotational speed of the motor increases the torque. The motor is controlled such that, when the rotational speed of the motor is constant, the torque of the motor is also constant.

During the speed change response control, a limit may be provided to the rate of increase in motor torque per unit time. For example, an upper limit may be provided to the rate of increase in the electric current of the motor being controlled by the motor controller 5. In such implementations, the motor controller 5 controls the electric current of the motor such that the rate of increase in the current of the motor does not exceed the upper limit during the speed change response control. This limits the rate of increase in the torque of the motor. The motor controller 5 may, for example, control the electric current of the motor such that the rate of increase in the torque of the motor does not exceed the upper limit when the electric power in the motor has not yet reached the target value. By way of example, the motor controller 5 may gradually increase the torque of the motor with a constant slope from the initiation of the speed change response control until the electric power in the motor reaches the target value. Further, the motor controller 5 may increase the torque of the motor at a limited rate of increase from the initiation of the speed change response control until the electric power in the motor reaches the target value, regardless of the rotational speed of the motor.

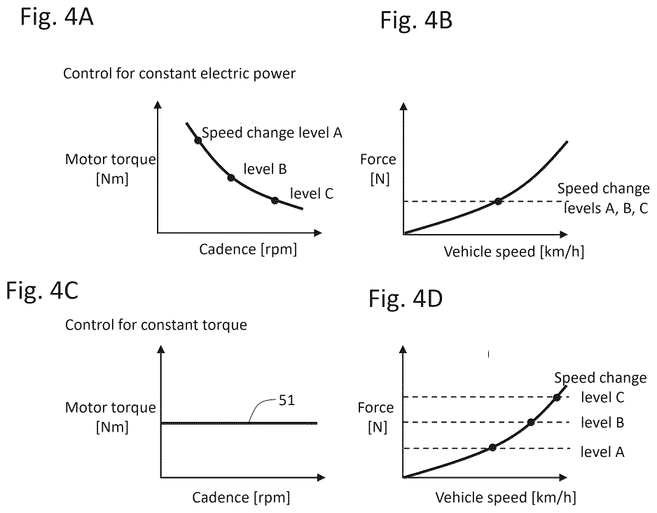

FIG. 4A is a graph illustrating one example of the relationship between motor torque and cadence when the speed change response control is performed. Cadence is defined as the number of rotations of the motor. FIG. 4B is a graph illustrating one example of the relationship between the driving force for the vehicle wheel and the vehicle speed when the driving force for the vehicle wheel and the load during travel are balanced when the speed change response control is performed. The electric power in the motor is controlled by the speed change response control to remain constant. As illustrated in FIG. 4A, a change in speed change level (i.e., speed change ratio) changes cadence. During the speed change response control, the motor controller 5 varies the torque of the motor so as to maintain a certain electric power even when the cadence changes. For example, when the speed change level changes from A to B, the cadence increases and the torque of the motor decreases. This control, which keeps the electric power in the motor constant, provides that, as illustrated in FIG. 4B, the driving force for the vehicle wheel in the balanced state remains substantially unchanged regardless of whether the speed change level is A, B, or C. Accordingly, even when switching occurs among speed change levels A, B, and C, the changes in vehicle speed are small or almost negligible.

FIG. 4C is a graph illustrating one example of the relationship between motor torque and cadence when the motor is controlled such that its torque remains constant. FIG. 4B is a graph illustrating one example of the relationship between the driving force for the vehicle wheel and vehicle speed when the driving force for the vehicle wheel and the load during travel are balanced when the motor is controlled such that its torque remains constant. As shown in these graphs, when the motor torque is controlled to remain constant regardless of cadence, changing the speed change level changes the driving force of the vehicle wheel in the balanced state. As a result, switching between speed change levels leads to a change in vehicle speed.

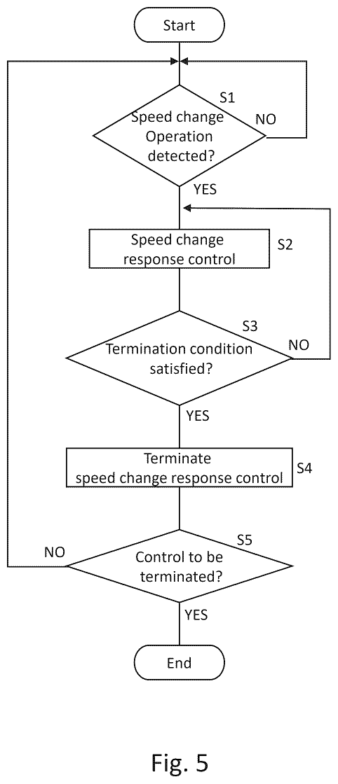

FIG. 5 is a flow chart showing an example of the operation of the motor controller 5. In the implementation of FIG. 5, if the motor controller 5 detects a speed change operation of the speed changer 48 (YES at step S1), the unit performs the speed change response control (S2). At step S1, the motor controller 5 detects, for example, a speed change operation based on a speed change signal from the speed change operation detector 51. In addition to detection of a speed change operation, vehicle speed, pedaling force, crank rotation, or other vehicle states may be added as conditions for the speed change response control in the determination at step S1.

During the speed change response control at step S2, the motor controller 5 controls the motor such that the electric power in the motor reaches a target value. The target value is a value that does not change over time. In other words, the motor is controlled such that the electric power therein remains constant. This control may be a feedback control (i.e., a control for achieving a constant amount) in which, for example, the detected rotational speed of the motor and the detected electric current of the motor are used to control the torque of the motor so as to bring the electric power in the motor closer to the target value.

When the speed change response control of step S2 is being performed and if it is determined that a speed change response control termination condition is satisfied (YES at step S3), the motor controller 5 terminates the speed change response control (S4). Speed change response control termination conditions used may be those discussed above. The process including steps S1 to S5 is repeatedly performed until the control by the motor controller 5 is terminated (YES at step S5). For example, the control by the motor controller 5 may be initiated and terminated in response to a turn-on and turn-off of the power supply of the motor control apparatus, for example.

In the implementation of FIG. 5, the motor controller 5 initiates the driving by the motor at the time of the initiation of the speed change response control of step S2, and stops the driving by the motor at the time of the termination of the speed change response control of step S4. In a variation, at the time of termination of the speed change response control, the motor controller 5 may not stop the driving by the motor and may switch the motor control to the assist control. For example, at step S3, when such a pedaling force as to require assistance, which is used as a speed change response control termination condition, is detected, then, at step S4, the motor controller 5 may switch from the speed change response control to the assist control.

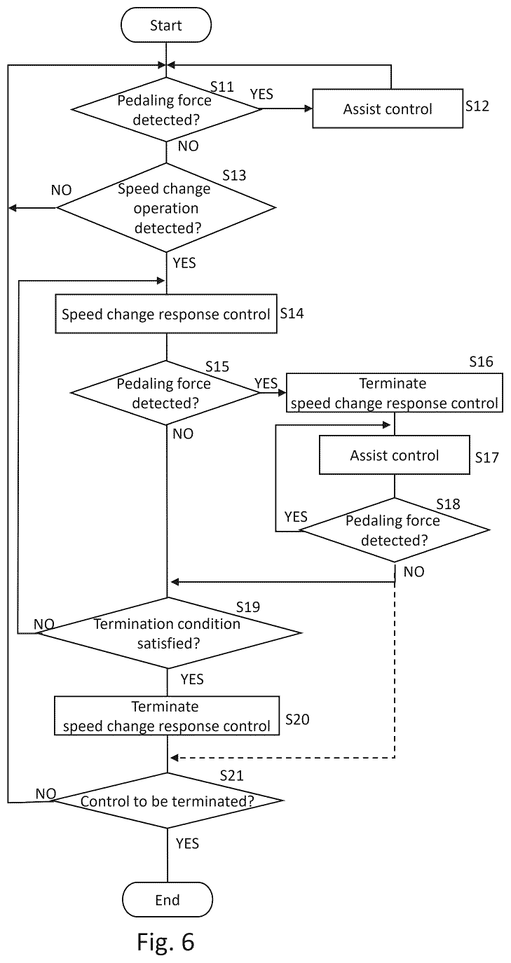

FIG. 6 is a flow chart showing another example of the operation of the motor controller 5. FIG. 6 shows an exemplary process in which the motor controller 5 performs the assist control at a higher priority than the speed change response control. In the implementation of FIG. 6, when such a pedaling force as to require assistance is detected (YES at step S11), the motor controller 5 performs the assist control (step S12). The assist control is a control that causes the motor to output a driving force depending on the user's pedaling force. In other words, the assist control is a control that causes the motor to output an assist force, which provides a propulsive force for the bicycle, depending on the detected pedaling force. The assist control may include, for example, a process that controls at least one of the electric current of or the voltage across the motor to bring the torque of the motor closer to a target torque that has been determined based on the pedaling force detected by the pedaling force sensor. If a pedaling force is detected (YES at step S11), the assist control is performed. If no pedaling force is detected (NO at step S11) and then a speed change operation is detected (YES at step S13), the speed change response control is performed (step S14). The detection of a speed change operation (S13) and the speed change response control (S14) may be performed in the same manner as steps S1 and S2 of FIG. 5, respectively.

When the speed change response control (S14) is being performed and if such a pedaling force as to require assistance is detected (YES at step S15), the motor controller terminates the speed change response control (S16) and performs the assist control (S17). The assist control is continuously performed as long as a pedaling force that requires assistance is detected (YES at step S18). When no pedaling force is detected anymore (NO at step S18), the assist control is terminated. If NO at step S18 and the assist control is terminated, by way of example, it is determined at step S19 whether a speed change response control termination condition is satisfied. If YES at step S19, the speed change response control is not resumed and remains terminated (S20). If NO at step S19, the speed change response control is performed once again (S14). In other words, the speed change response control is resumed. Thus, during the speed change response control and if a pedaling force by the user is detected, the motor controller 5 stops the speed change response control and performs the assist control. Then, if the assist control is terminated before a speed change response control termination condition is satisfied, the stopped speed change response control may be resumed.

In a variation, if NO at step S18 and the assist control is terminated, the determination of step S19 may not be performed and the speed change response control termination may be maintained (indicated by the broken line for “NO” at step S18). In such implementations, if a pedaling force by the user is detected during the speed change response control, the motor controller 5 may stop the speed change response control and perform the assist control, and, if the assist control is terminated before a speed change response control termination condition is satisfied, the stopped speed change response control may not be resumed.

In FIG. 6, the process including steps S11 to S20 is repeatedly performed until the control is terminated by the power supply of the motor control apparatus being turned off, for example (YES at step S21). In the implementation of FIG. 6, the motor controller 5 is configured or programmed to perform both the assist control and the speed change response control, and may perform the assist control at a higher priority than the speed change response control. The operation in FIG. 6 enables a motor control that supports a speed change operation in such a manner that, for example, when the user is not pedaling and if the vehicle is traveling by inertia and a speed change operation is performed, the user perceives no changes in the vehicle speed.

In the implementation of FIG. 2, the first rotating body 1 includes one sprocket 1a, and the second rotating body 2 includes a plurality of sprockets 2a to 2f. In a variation, each of the first and second rotating bodies 1 and 2 may include a plurality of sprockets. In such implementations, the speed changer 48 includes a front derailleur that changes the sprocket of the first rotating body 1 on which the transmission link 46 is positioned, and a rear derailleur that changes the sprocket of the second rotating body 2 on which the transmission link 46 is positioned. In such implementations, the speed change operator 47 may include an operator to operate the front derailleur and an operator to operate the rear derailleur.

Further, the first and second rotating bodies 1 and 2 may be provided in a gearbox. In such implementations, for example, the speed changer 48 may also be provided inside the gearbox.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor control apparatus for a bicycle including a crankshaft to receive a pedaling force; a vehicle wheel; a transmission including a first rotating body including at least one sprocket coupled to the crankshaft, a second rotating body including at least one sprocket coupled to the vehicle wheel, and a transmission link to transmit a driving force from the first rotating body to the second rotating body, at least one of the first rotating body or the second rotating body including a plurality of sprockets; a speed changer to change a speed change ratio by changing a combination of a sprocket of the first rotating body from which the transmission link transmits a driving force and a sprocket of the second rotating body to which the transmission link transmits a driving force; and a motor to supply the transmission link with a driving force, the motor control apparatus comprising:
a motor controller configured or programmed to control the motor; wherein
upon receiving a speed change signal indicative of a speed change operation by the speed changer, the motor controller is configured or programmed to perform a speed change response control to control the motor such that electric power in the motor remains constant.

2. The motor control apparatus according to claim 1, wherein, during the speed change response control, the motor controller is configured or programmed to control the motor such that the electric power remains constant by controlling at least one of an electric current of or an electric voltage across the motor depending on a rotational speed of the motor or the electric voltage across the motor.

3. The motor control apparatus according to claim 1, wherein the motor controller is configured or programmed to perform the speed change response control when a vehicle speed of the bicycle at a time of receiving the speed change signal satisfies a predetermined vehicle speed condition, and to not perform the speed change response control when the vehicle speed of the bicycle at the time of receiving the speed change signal does not satisfy the predetermined vehicle speed condition.

4. The motor control apparatus according to claim 1, wherein the motor controller is configured or programmed to terminate the speed change response control when a speed change response control termination condition is satisfied.

5. The motor control apparatus according to claim 4, wherein the speed change response control termination condition includes an amount of rotation of the first rotating body reaching a first threshold value or an amount of rotation of the second rotating body reaching the first threshold value.

6. The motor control apparatus according to claim 4, wherein the speed change response control termination condition includes a change in a number of motor rotations satisfying a predetermined condition.

7. The motor control apparatus according to claim 1, wherein the motor controller is configured or programmed to perform an assist control to cause the motor to output a driving force depending on a pedaling force by a user at a higher priority than the speed change response control.

8. The motor control apparatus according to claim 7, wherein
the motor controller is configured or programmed to terminate the speed change response control when a speed change response control termination condition is satisfied; and
during the speed change response control, the motor controller is configured or programmed to stop the speed change response control and perform the assist control when the pedaling force by the user is detected, and does not resume the stopped speed change response control when the assist control has been terminated before the speed change response control termination condition is satisfied.

9. The motor control apparatus according to claim 7, wherein:
the motor controller is configured or programmed to terminate the speed change response control when the speed change response control termination condition is satisfied; and
during the speed change response control, the motor controller is configured or programmed to stop the speed change response control and perform the assist control when a pedaling force by the user is detected, and resume the stopped speed change response control when the assist control is terminated before the speed change response control termination condition is satisfied.

10. The motor control apparatus according to claim 1, wherein the motor controller includes a limit of a rate of increase in a torque of the motor per unit time during the speed change response control.

11. A bicycle comprising:
a crankshaft to receive a pedaling force;
a vehicle wheel;
a transmission including a first rotating body including at least one sprocket coupled to the crankshaft, a second rotating body including at least one sprocket coupled to the vehicle wheel, and a transmission link to transmit a driving force from the first rotating body to the second rotating body, at least one of the first rotating body or the second rotating body including a plurality of sprockets;
a speed changer to change a speed change ratio by changing a combination of a sprocket of the first rotating body from which the transmission link transmits a driving force and a sprocket of the second rotating body to which the transmission link transmits a driving force;
a motor to supply the transmission link with a driving force; and
a motor controller configured or programmed to control the motor; wherein
upon receiving a speed change signal indicative of a speed change operation by the speed changer, the motor controller is configured or programmed to perform a speed change response control to control the motor such that electric power in the motor remains constant.
